(19) United States
(12) Patent Application Publication
(10) Pub. No.: US 2011/0222418 A1
(43) Pub. Date: Sep. 15, 2011

(54) APPARATUS AND METHOD FOR REDUCING ENERGY CONSUMPTION IN WIRELESS COMMUNICATION SYSTEM

(75) Inventors: Hyon-Goo KANG, Suwon-si (KR); Hyeong-Jong JU, Suwon-si (KR)

(73) Assignee: SAMSUNG ELECTRONICS CO. LTD., Suwon-si (KR)

(21) Appl. No.: 13/042,869

(22) Filed: Mar. 8, 2011

(30) Foreign Application Priority Data
Mar. 11, 2010 (KR) 10-2010-0021672

(51) Int. Cl. H04W 52/02; H04W 24/00

(52) U.S. Cl. 370/252; 370/311

(57) ABSTRACT

An apparatus and a method for controlling an Energy Saving (ES) mode at a base station of a wireless communication system are provided. The method for controlling the ES mode includes predicting a traffic load of a next time, determining whether to enter the ES mode using the predicted traffic load, when determining to enter the ES mode, determining reliability of the predicted traffic load, and when the predicted traffic load is reliable, operating in the ES mode.

### PRIORITY

The present application claims the benefit under 35 U.S.C. §119(a) of a Korean patent application filed in the Korean Intellectual Property Office on Mar. 11, 2010, and assigned Serial No. 10-2010-0021672, the entire disclosure of which is hereby incorporated by reference.

### BACKGROUND OF THE INVENTION

1. Field of the Invention

The present invention relates to an apparatus and a method for reducing energy consumption in a wireless communication system. More particularly, the present invention relates to an apparatus and a method for reducing energy consumption of a base station in a packet-based wireless communication system.

2. Description of the Related Art

Recently, as concerns about the environment are increasing, an Energy Saving (ES) mode for optimizing energy consumption of a base station is drawing attention.

The amount of traffic processed in a wireless communication system changes with time. That is, the amount of traffic processed by a base station that services the same region changes according to the behavior pattern change of a user and a terminal. For example, the traffic pattern varies in the daytime as compared to the night, varies by day of the week, and varies according to the number of users and terminals.

As stated above, for the ES mode of the base station, the wireless communication system predicts the traffic pattern through time series analysis. However, the traffic pattern of the wireless communication system has not only characteristics of a simple random walk model but also trend and seasonality. Accordingly, the wireless communication system requires a method for more accurately predicting the traffic pattern for a more precise ES.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for controlling an Energy Saving (ES) mode of a base station in a wireless communication system.

Another aspect of the present invention is to provide an apparatus and a method for predicting a traffic pattern of a base station in a wireless communication system.

A further aspect of the present invention is to provide an apparatus and a method for controlling an ES mode of a base station in a packet-based wireless communication system.

Yet another aspect of the present invention is to provide an apparatus and a method for controlling an ES mode according to a traffic pattern of a base station in a packet-based wireless communication system.

In accordance with an aspect of the present invention, a method for controlling an ES mode at a base station of a wireless communication system is provided. The method includes predicting a traffic load of a next time, determining whether to enter the ES mode using the predicted traffic load, when determining to enter the ES mode, determining reliability of the predicted traffic load, and, when the predicted traffic load is reliable, operating in the ES mode.

In accordance with another aspect of the present invention, an apparatus for controlling an ES mode at a base station of a wireless communication system is provided. The apparatus includes a traffic estimator for predicting a traffic load of a next time, a traffic abnormality determiner for determining reliability of the traffic load predicted by the traffic estimator, and a controller for determining whether to enter the ES mode using the traffic load predicted by the traffic estimator, and for controlling to operate in the ES mode when the determining that the traffic load predicted by the traffic estimator is reliable.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates a wireless communication system according to an exemplary embodiment of the present invention;

FIG. 2 illustrates a method of a base station for transiting to an Energy Saving (ES) mode in a wireless communication system according to an exemplary embodiment of the present invention; and

FIG. 3 illustrates a base station in a wireless communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

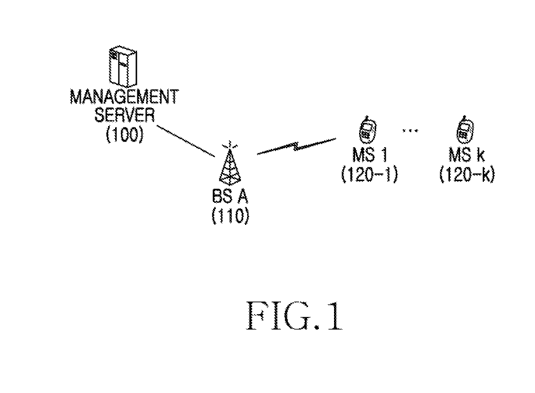

FIGS. 1 through 3, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

Exemplary embodiments of the present invention provide a technique for controlling an Energy Saving (ES) mode of a base station in a wireless communication system.

Hereafter, it is assumed that the ES mode of the base station is controlled according to a traffic pattern of the base station in a packet-based wireless communication system.

An exemplary wireless communication system is constructed as shown in FIG. 1.

FIG. 1 depicts a wireless communication system according to an exemplary embodiment of the present invention.

The wireless communication system of FIG. 1 includes a management server 100, a base station 110, and mobile stations 120-1 through 120-k.

The management server 100 provides the base station 110 with an inter-cell handoff processing function, a call control function, an ES mode control function, and an operation and maintenance control function of the base station, in conjunction with at least one base station 110.

The base station 110 provides mobile communication service to one or more mobile stations 120-1 through 120-k traveling in its service coverage.

The base station 110 controls the ES mode by analyzing a traffic pattern according to the service. For example, the base station 110 determines whether to enter the ES mode by estimating a traffic load of a next time. When determining to enter the ES mode, the base station 110 determines whether to stay in the ES mode by analyzing a risk of the predicted traffic load. Herein, the next time indicates a time interval after the base station 110 provides the service.

Now, an exemplary method of the base station for controlling the ES mode according to the traffic pattern is explained.

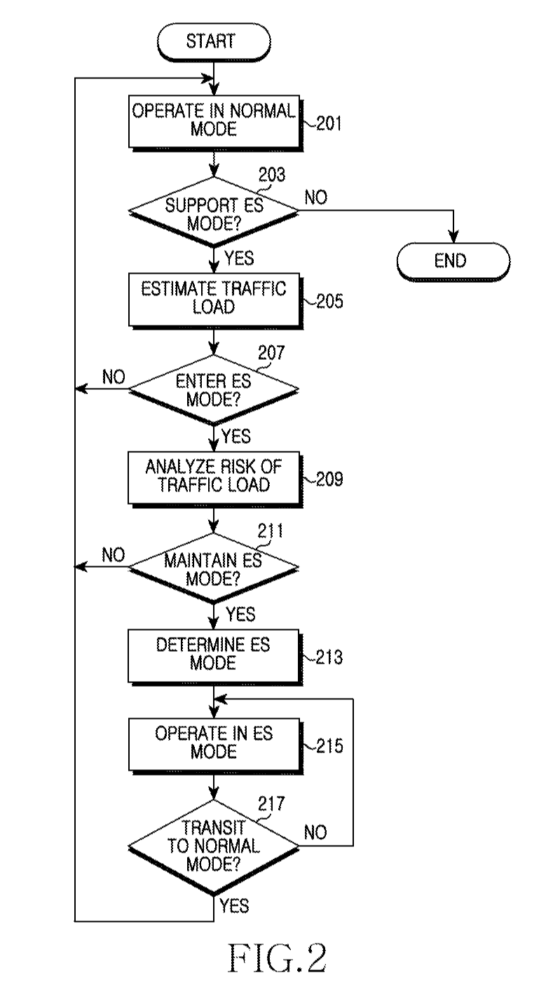

FIG. 2 illustrates a method of a base station for transiting to the ES mode in a wireless communication system according to an exemplary embodiment of the present invention.

In step 201, the base station operates in a normal mode. At this time, the base station aggregates traffic load data of the current service time. Herein, the normal mode indicates a general operation mode of the base station when the base station does not work in the ES mode.

In step 203, the base station determines whether it supports the ES mode. For example, the base station determines whether a system operator permits the ES mode. Based on reliability of an ES mode procedure, the system operator can limit the ES mode operation method to several stages.

If it is determined in step 203 that the base station does not support the ES mode, the base station finishes this process.

On the other hand, if it is determined in step 203 that the base station does support the ES mode, the base station predicts the traffic load of the next time in step 205. For instance, when the next time is the (i+1)-th time, the base station predicts the traffic load of the (i+1)-th time using a weighted moving average scheme based on Equation 1. Herein, the next time indicates the time interval after the base station provides the service.

$${X}_{d ( i + 1 )} = {\sum }_{m = 0}^{M - 1} {W}_{m} {Y}_{d ( i - m )} \qquad ( 1 )$$

In Equation 1, X_{d(i+1)} denotes the traffic load of the (i+1)-th time on a date d, and M denotes a mean size for predicting the traffic load using the weighted moving average. Wₘ denotes a weight at the m-th time for the weighted moving average, and Y_{d(i-m)} denotes the traffic load collected at the (i−m)-th time on the date d.

In step 207, the base station determines whether to enter the ES mode at the next time using the traffic load prediction value of the next time. For example, the base station determines whether to enter the ES mode at the next time by comparing the traffic load prediction value of the next time and a threshold. When there are k-ary ES mode stages and the k-th ES mode is suitable for the base station, the base station compares the traffic load prediction value X_{d(i+1)} of the next time with a threshold Thₖ of the k-th ES mode and a threshold Th₍ₖ₊₁₎ of the (k+1)-th ES mode. When the traffic load prediction value is smaller than Thₖ and greater than or equal to Th₍ₖ₊₁₎ (Thₖ>X_{d(i+1)}≧Th₍ₖ₊₁₎, the base station determines to enter the ES mode at the next time. Herein, it is assumed that Thₖ is greater than Th₍ₖ₊₁₎.

If it is determined not to enter the ES mode at the next time in step 207, the base station goes to step 201 to operate in the normal mode at the next time.

On the other hand, if it is determined to enter the ES mode at the next time in step 207, the base station analyzes the risk of the traffic load predicted in step 205, in step 209. That is, the base station determines whether the traffic load predicted in step 205 is reliable. For example, when detecting fault of the base station or a neighbor base station, the base station determines that the predicted traffic load is unreliable. That is, upon detecting fault of the neighbor base station, the base station recognizes that the traffic load will increase due to the fault of the neighbor base station. Hence, the base station determines that the predicted traffic load is unreliable.

For example, when the traffic load value of the current time collected in step 201 belongs to at least one of time series analysis bases, the base station can determine that the predicted traffic load is unreliable.

For example, when the correlation value of the traffic load prediction value up to the current time and the traffic load measurement value is smaller than a reference correlation value, the base station can determine that the predicted traffic load is unreliable.

In step 211, the base station determines whether to stay in the ES mode in the next time, according to the risk of the predicted traffic load. That is, the base station determines whether to operate in the ES mode in the next time, according to the reliability of the predicted traffic load.

When the predicted traffic load is unreliable, the base station determines in step 211 that it cannot operate in the ES mode in the next time. Thus, the base station returns to step 201 to operate in the normal mode in the next time as well.

In contrast, when the predicted traffic load is reliable, the base station determines in step 211 to operate in the ES mode in the next time. Accordingly, the base station determines the ES mode to operate in the next time in step 213. For example, the base station can support ES modes such as power amplifier bias change, Error Vector Magnitude (EVM) change, radio resource restriction, and cell off. Hence, the base station selects the ES mode to operate in the next time among the ES modes. That is, the base station can select whether to enter the ES mode, whether to stay in the ES mode, and the ES mode, using state information based on the ES mode as shown in Table 1.

TABLE 1

| | | | | #of Avail- |
|---|---|---|---|---|
| | Traffic | PA Bias | Antenna | able RBs |
| Threshold | Load | Voltage | Mode | (10 MHz) |
| — | 70% | 31 V | 2 × 2 MIMO | 50 RBs |
| Th₁ = 70% | 60~70% | 29 V | 2 × 2 MIMO | 40 RBs |
| Th₂ = 60% | 50~60% | 27 V | 2 × 2 MIMO | 30 RBs |
| Th₃ = 50% | 40~50% | 25 V | 2 × 2 MIMO | 25 RBs |
| Th₄ = 40% | ~40% | 31 V | 1 × 2 SIMO | 25 RBs |

When the next time arrives in step 213, the base station works in the selected ES mode in step 215.

In step 217, the base station determines whether to transit to the normal mode. That is, the base station determines whether to maintain the ES mode by continuously determining system abnormality.

If it is determined not to stay in the ES mode in step 217, the BS operates in the normal mode in step 201. Alternatively, the base station may determine whether the ES mode is supported in step 203.

If it is determined to maintain the ES mode in step 217, the base station stays in the ES mode in step 215.

In this exemplary embodiment, when the traffic load value of the current time collected in the normal mode corresponds to the time series analysis basis, the base station can determine that the predicted traffic load is unreliable. At this time, eight time series analysis bases can be defined as below.

First, the base station determines whether the traffic load value Y_{di} of the current time exceeds a management bound σ_{di}. That is, the base station determines whether the traffic load of the current time satisfies a condition of Equation 2. When the traffic load of the current time satisfies the condition of Equation 2, the base station determines that the predicted traffic load is unreliable.

$${Y}_{di} > {Mean}_{di} + 3 {σ}_{di} or {Y}_{di} < {Mean}_{di} - 3 {σ}_{di} \\ {Mean}_{di} = \frac{1}{D} {\sum }_{j = 0}^{D - 1} {Y}_{( d - j ) i} , {σ}_{di}^{2} = \frac{1}{D} {\sum }_{j = 0}^{D - 1} {Y}_{( d - j ) i}^{2} - {Mean}_{di}^{2} \qquad ( 2 )$$

In Equation 2, Y_{di} denotes the traffic load collected at the i-th time on the date d, Mean_{di} denotes a mean of the traffic load accumulated until the i-th time on the date d, σ_{di} denotes a mean of the traffic load until the previous time, and D denotes the number of valid dates for the ES mode determination.

Secondly, the base station determines whether the traffic load moves. For example, the base station determines whether the traffic load value Y_{di} of the current time continuously appears in a certain side based on the center line, based on Equation 3. When the traffic load of the current time satisfies the condition of Equation 3, the base station determines that the predicted traffic load is unreliable.

Y_{(d-j)i}>Mean_{di} for all j=0, . . . , 7 or Y_{(d-j)i}<Mean_{di} for all j=0, . . . , 7 (3)

Y_{(d-j)i} denotes the traffic load collected at the i-th time on the date (d−j), and Mean_{di} denotes the mean of the traffic load accumulated until the i-th time on the date d.

Thirdly, the base station determines tendency of the traffic load. For example, the base station examines whether the traffic load value continues to increase or decrease, based on Equation 4. When the traffic load of the current time satisfies the condition of Equation 4, the base station determines that the predicted traffic load is unreliable.

Y_{di}>Y_{(d-1)i}>Y_{(d-2)i}>Y_{(d-3)i}>Y_{(d-4)i}>Y_{(d-5)i} or Y_{di}<Y_{(d-1)i}<Y_{(d-2)i}<Y_{(d-3)i}<Y_{(d-4)i}<Y_{(d-5)i} (4)

Y_{(d-j)i} denotes the traffic load collected at the i-th time on the date (d−j).

Fourthly, the base station determines vibration of the traffic load. For example, the base station determines whether the traffic load value exhibits the continuous vibration, based on Equation 5. When the traffic load of the current time satisfies the condition of Equation 5, the base station determines that the predicted traffic load is unreliable.

(Y_{(d-j)i}−Mean_{di})(Y_{(d-j-1)i}−Mean_{di})<0 for all j=0, . . . , 12 (5)

In Equation 5, Y_{(d-j)i} denotes the traffic load collected at the i-th time on the date (d−j) and Mean_{di} denotes the mean of the traffic load accumulated until the i-th time on the date d.

Fifthly, the base station determines whether the successive traffic load values lie between two reference points 2σ_{di} and 3σ_{di}. For example, the base station determines whether the condition of Equation 6 is satisfied. When the traffic load of the current time satisfies the condition of Equation 6, the base station determines that the predicted traffic load is unreliable.

Y_{di}>Mean_{di}+2σ_{di} or Y_{di}<Mean_{di}−2σ_{di}

Y_{(d-1)i}>Mean_{di}+2σ_{di} or Y_{(d-1)i}<Mean_{di}−2σ_{di}

Y_{(d-2)i}>Mean_{di}+2σ_{di} or Y_{(d-2)i}<Mean_{di}−2σ_{di} (6)

In Equation 6, Y_{(d-j)i} denotes the traffic load collected at the i-th time on the date (d−j), Mean_{di} denotes the mean of the traffic load accumulated until the i-th time on the date d, and σ_{di} denotes the mean of the traffic load until the previous time.

Sixthly, the base station determines whether four of the five successive traffic load values lie between two reference points 1σ_{di} and 3σ_{di}. For example, the base station determines whether the condition of Equation 7 is satisfied. When the traffic load of the current time satisfies the condition of Equation 7, the base station determines that the predicted traffic load is unreliable.

$${Y}_{di} > {Mean}_{di} + {σ}_{di} , {\sum }_{j = 1}^{4} \frac{{Y}_{( d - j ) i} - {Mean}_{di} - {σ}_{di}}{\sqrt{{Y}_{( d - j ) i} - {Mean}_{di} - {σ}_{di}^{2}}} \geq 2 \\ or \\ {Y}_{di} < {Mean}_{di} - {σ}_{di} , {\sum }_{j = 1}^{4} \frac{{Y}_{( d - j ) i} - {Mean}_{di} + {σ}_{di}}{\sqrt{{Y}_{( d - j ) i} - {Mean}_{di} + {σ}_{di}^{2}}} \leq - 2 \qquad ( 7 )$$

Y_{di} denotes the traffic load collected at the i-th time on the date d, Mean_{di} denotes the mean of the traffic load accumulated until the i-th time on the date d, and σ_{di} denotes the mean of the traffic load until the previous time.

Seventhly, the base station determines whether the traffic load is stratified. For example, the base station examines whether the traffic load value continuously appears in the reference value 1σ_{di} based on Equation 8. When the traffic load of the current time satisfies the condition of Equation 8, the base station determines that the predicted traffic load is unreliable.

Mean_{di}−σ_{di}<Y_{(d-j)i}<Mean_{di}+σ_{di} for all j=0, . . . , 14 (8)

In Equation 8, Y_{(d-j)i} denotes the traffic load collected at the i-th time on the date (d−j), Mean_{di} denotes the mean of the traffic load accumulated until the i-th time on the date d, and σ_{di} denotes the mean of the traffic load until the previous time.

Lastly, the base station determines whether the traffic load is mixed. For example, the base station examines whether the traffic load value continuously appears in the reference values σ_{di} and 3σ_{di} based on Equation 9. When the traffic load of the current time satisfies the condition of Equation 9, the base station determines that the predicted traffic load is unreliable.

Y_{(d-j)i}>Mean_{di}+σ_{di} or Y_{(d-j)i}<Mean_{di}−σ_{di} for j=0, . . . , 7

In Equation 9, Y_{di} denotes the traffic load collected at the i-th time on the date d, Mean_{di} denotes the mean of the traffic load accumulated until the i-th time on the date d, and σ_{di} denotes the mean of the traffic load until the previous time.

In this exemplary embodiment, the base station determines the risk of the traffic load by comparing the correlation value of the traffic load prediction value up to the current time and the traffic load measurement value, with the reference correlation value. In so doing, the base station calculates the correlation value of the traffic load prediction value up to the current time and the traffic load measurement value based on Equation 10.

$$r ( {P}_{X} , {P}_{Y} ) = \frac{N {\sum }_{j = 0}^{N - 1} {P}_{X ( i - j )} {P}_{Y ( i - j )} - 1}{\sqrt{N {\sum }_{j = 0}^{N - 1} {P}_{X ( i - j )}^{2} - 1} \sqrt{N {\sum }_{j = 0}^{N - 1} {P}_{Y ( i - j )}^{2} - 1}} \\ {P}_{X ( i - j )} = \frac{{X}_{d ( i - j )}}{{\sum }_{k = 0}^{N - 1} {X}_{d ( i - k )}} , \\ {P}_{Y ( i - j )} = \frac{{Y}_{d ( i - j )}}{{\sum }_{k = 0}^{N - 1} {Y}_{d ( i - k )}} for all j = 0 , … , N - 1 \qquad ( 10 )$$

In Equation 10, P_{di} denotes a ratio of the traffic load of the i-th time on the date d to one-day prediction value, Y_{di} denotes the value collecting the traffic load of the i-th time on the date d, X_{di} denotes the prediction value of the traffic load of the i-th time on the date d, and N denotes the total number of the ES mode determinations a day.

Now, an exemplary structure of a base station for controlling an ES mode is explained. Hereafter, modules that may be omitted from the base station shall be marked with the dotted line.

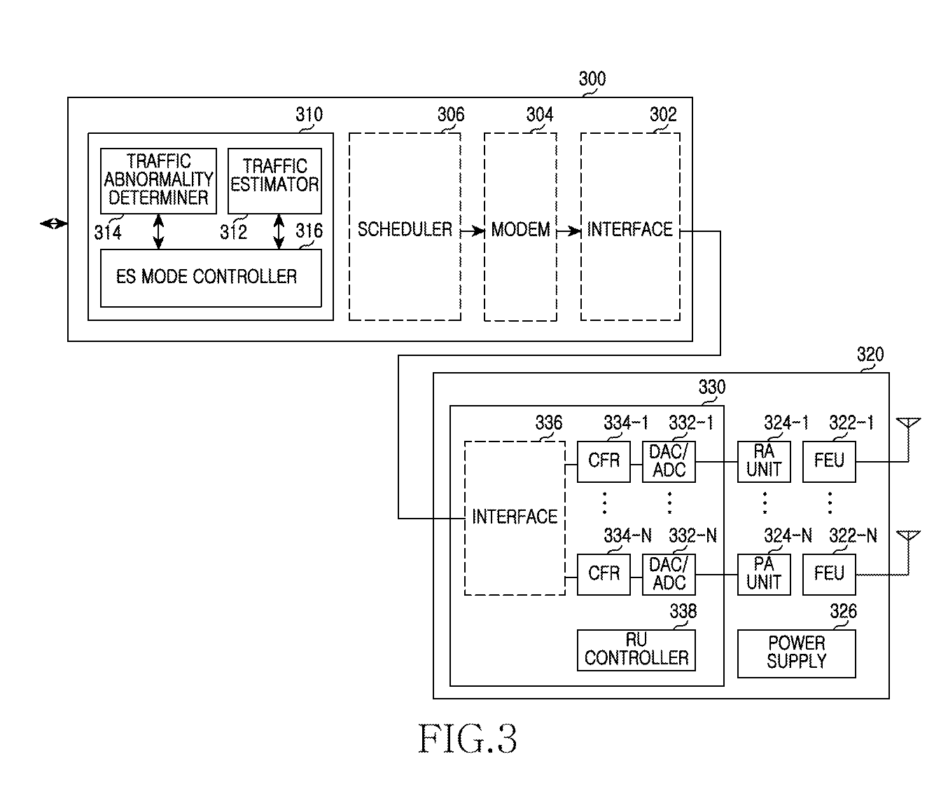

FIG. 3 is a block diagram of a base station in a wireless communication system according to an exemplary embodiment of the present invention.

The base station of FIG. 3 includes a Digital Unit (DU) 300 and a Remote Unit (RU) 320.

The DU 300 includes an interface 302, a modem 304, a scheduler 306, and a controller 310.

The interface 302 transmits and receives signals to and from the RU 320.

The modem 304 modulates and demodulates a baseband signal. For example, the modem 304 restores a signal output from the interface 302, and encodes and modulates a signal to send to the RU 320 via the interface 302.

The scheduler 306 allocates resources for providing the service through scheduling.

The controller 310 includes a traffic estimator 312, a traffic abnormality determiner 314, and an ES mode controller 316.

The traffic estimator 312 estimates the traffic load of the next time. For instance, the traffic estimator 312 predicts the traffic load of the next time using the weighted moving average scheme based on Equation 1.

The traffic abnormality determiner 314 analyzes the risk of the traffic load estimated by the traffic estimator 312 under the control of the ES mode controller 316. More specifically, the traffic abnormality determiner 314 examines whether the traffic load estimated by the traffic estimator 312 is reliable. For example, when the fault of the base station or the neighbor base station is detected, the traffic abnormality determiner 314 determines that the traffic load estimated by the traffic estimator 312 is unreliable. That is, whether the fault of the neighbor base station is detected, the traffic abnormality determiner 314 recognizes that the traffic load will increase due to the fault of the neighbor base station. Hence, the traffic abnormality determiner 314 determines that the traffic load estimated by the traffic estimator 312 is unreliable.

For example, when the traffic load value collected in the current time belongs to at least one of the time series analysis bases, the traffic abnormality determiner 314 can determine that the traffic load estimated by the traffic estimator 312 is unreliable.

For example, when the correlation value of the traffic load prediction value up to the current time and the traffic load measurement value is smaller than the reference correlation value, the traffic abnormality determiner 314 may determine that the traffic load estimated by the traffic estimator 312 is unreliable.

The ES mode controller 316 determines whether the base station enters the ES mode in the next time, using the traffic load prediction value provided from the traffic estimator 312. For example, the ES mode controller 316 determines whether to enter the ES mode at the next time by comparing the traffic load prediction and the threshold. When there are k-ary ES mode stages and the k-th ES mode is suitable for the base station, the ES mode controller 316 compares the traffic load prediction value X_{d(i+1)} with the threshold Thₖ of the k-th ES mode and the threshold Th₍ₖ₊₁₎ of the (k+1)-th ES mode. When the traffic load prediction value is smaller than Thₖ and greater than or equal to Th₍ₖ₊₁₎ (Thₖ>X_{d(i+1)}≧Th₍ₖ₊₁₎), the ES mode controller 316 determines to enter the ES mode at the next time. Herein, it is assumed that Thₖ is greater than Th₍ₖ₊₁₎.

When the traffic abnormality determiner 314 determines that the traffic load estimated by the traffic estimator 312 is reliable, the ES mode controller 316 determines to maintain the ES mode. By contrast, when the traffic abnormality determiner 314 determines that the traffic load estimated by the traffic estimator 312 is unreliable, the ES mode controller 316 determines to operate in the normal mode.

Upon determining to stay in the ES mode, the ES mode controller 316 selects the ES mode to operate in the next time. For example, the base station can support the ES modes such as power amplifier bias change, EVM change, radio resource restriction, and cell off.

When the base station works in the ES mode, the ES mode controller 316 continuously determines the abnormality of the system. Upon detecting the abnormality of the system, the ES mode controller 316 controls the base station to operate in the normal mode.

The RU 320 includes one or more Front End Units (FEUs) 322-1 through 322-N, one or more Power Amplifier Units (PAUs) 324-1 through 324-N, a power supply 326, and a transceiver 330.

The FEUs 322-1 through 322-N convert a Radio Frequency (RF) signal received over antennas to an Intermediate Frequency (IF) signal, convert an IF signal to send over the antennas to an RF signal, and transmit the RF signal through the antennas. For example, according to a Frequency Division Duplex (FDD) scheme, the FEUs 322-1 through 322-N include an RF duplexer filter or a circulator. According to a Time Division Duplex (TDD) scheme, the FEUs 322-1 through 322-N include a TDD switch and an RF filter.

The PAUs 324-1 through 324-N amplify power of the signal output from the transceiver 330 in respective transmit paths.

The power supply 326 supplies power for operating the modules of the base station.

The transceiver 330 includes one or more signal converters 332-1 through 332-N, one or more Crest Factor Reductions (CFRs) 334-1 through 334-N, an interface 336, and an RU controller 338.

The signal converters 332-1 through 332-N convert an analog signal provided in respective receive paths, to a digital signal, and convert a digital signal output from the CFRs 334-1 through 334-N to an analog signal.

The CFRs 334-1 through 334-N reduce Peak-to-Average Power Ratio (PAPR) of the transmit signal.

The interface 336 transmits and receives signals to and from the DU 330.

The RU controller 338 controls operations of the RU 320. For instance, the RU controller 338 controls the modules of the RU 320 according to the ES mode determined by the ES mode controller 316.

As set forth above, the ES mode of the base station is controlled based on the traffic pattern of the base station in the packet-based wireless communication system. Therefore, it is possible to raise the reliability in the system operation and to reduce the energy consumption of the base station.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling an Energy Saving (ES) mode at a base station of a wireless communication system, the method comprising:
predicting a traffic load of a next time;
determining whether to enter the ES mode using the predicted traffic load;
when determining to enter the ES mode, determining reliability of the predicted traffic load; and
when the predicted traffic load is reliable, operating in the ES mode.

2. The method of claim 1, wherein the determining of the reliability of the traffic load comprises:
determining the reliability of the predicted traffic load according to whether a fault of the base station or at least one neighbor base station is detected.

3. The method of claim 2, wherein the determining of the reliability of the traffic load further comprises:
when not detecting the fault of the base station or the at least one neighbor base station, determining that the predicted traffic load is reliable; and
when detecting the fault of the base station or the at least one neighbor base station, determining that the predicted traffic load is unreliable.

4. The method of claim 1, wherein the determining of the reliability of the traffic load comprises:
comparing a traffic load of a current time with at least one time series analysis basis; and
when the traffic load of the current time belongs to the at least one time series analysis basis, determining that the predicted traffic load is unreliable.

5. The method of claim 4, wherein the at least one time series analysis basis comprises at least one of excess of the traffic load of the current time over a management bound σ_{di}, wherein σ_{di} denotes the mean of the traffic load until the previous time, movement of the traffic load, tendency of the traffic load, vibration of the traffic load, appearance of consecutive traffic load values between two reference points, appearance of four of five consecutive traffic load values between two reference points, stratification of the traffic load, and mixing of the traffic load,
wherein the movement implies that the traffic load value of the current time continuously appears in one side based on a center line,
the tendency implies that the traffic load continuously increases or decreases,
the vibration implies that the traffic load value continuously vibrates,
the stratification implies that the traffic load value continuously falls within a reference value, and
the mixing implies that the traffic load value continuously falls within two reference values.

6. The method of claim 1, wherein the determining of the reliability of the traffic load comprises:
comparing a correlation value of a traffic load prediction value up to the current time and a traffic load measurement value up to the current time, with a reference correlation value; and
when the correlation value is smaller than the reference correlation value, determining that the predicted traffic load is unreliable.

7. The method of claim 1, wherein the operating of the ES mode comprises:
selecting any one of one or more ES mode operation manners; and
operating in the ES mode according to the selected ES mode operation manner.

8. The method of claim 7, wherein the ES mode operation manner comprises at least one of power amplifier bias change, Error Vector Magnitude (EVM) change, radio resource restriction, and cell off.

9. The method of claim 1, further comprising:
when operating in the ES mode, determining abnormality of a system,
wherein whether to maintain the ES mode is determined according to the abnormality determination of the system.

10. The method of claim 9, wherein, when detecting the abnormality of the system, the traffic load of the next time is predicted.

11. An apparatus for controlling an Energy Saving (ES) mode at a base station of a wireless communication system, the apparatus comprising:
a traffic estimator for predicting a traffic load of a next time;
a traffic abnormality determiner for determining reliability of the traffic load predicted by the traffic estimator; and
a controller for determining whether to enter the ES mode using the traffic load predicted by the traffic estimator, and for controlling to operate in the ES mode when the determining that the traffic load predicted by the traffic estimator is reliable.

12. The apparatus of claim 11, wherein the traffic abnormality determiner determines the reliability of the traffic load predicted by the traffic estimator according to whether a fault of the base station or at least one neighbor base station is detected.

13. The apparatus of claim 12, wherein, when not detecting the fault of the base station or the at least one neighbor base station, the traffic abnormality determiner determines that the traffic load predicted by the traffic estimator is reliable, and
when detecting the fault of the base station or the at least one neighbor base station, the traffic abnormality determiner determines that the traffic load predicted by the traffic estimator is unreliable.

14. The apparatus of claim 11, wherein, when the traffic load of the current time belongs to at least one time series analysis basis, the traffic abnormality determiner determines that the traffic load predicted by the traffic estimator is unreliable.

15. The apparatus of claim 14, wherein the at least one time series analysis basis comprises at least one of excess of the traffic load of the current time over a management bound σ_{di}, wherein σ_{di} denotes the mean of the traffic load until the previous time, movement of the traffic load, tendency of the traffic load, vibration of the traffic load, appearance of consecutive traffic load values between two reference points, appearance of four of five consecutive traffic load values between two reference points, stratification of the traffic load, and mixing of the traffic load,
wherein the movement implies that the traffic load value of the current time continuously appears in one side based on a center line,
the tendency implies that the traffic load continuously increases or decreases,
the vibration implies that the traffic load value continuously vibrates,
the stratification implies that the traffic load value continuously falls within a reference value, and
the mixing implies that the traffic load value continuously falls within two reference values.

16. The apparatus of claim 11, wherein, when a correlation value of a traffic load prediction value up to the current time and a traffic load measurement value up to the current time is smaller than a reference correlation value, the traffic abnormality determiner determines that the traffic load predicted by the traffic estimator is unreliable.

17. The apparatus of claim 11, wherein the controller selects any one of one or more ES mode operation manners, and controls to operate in the ES mode according to the selected ES mode operation manner.

18. The apparatus of claim 17, wherein the ES mode operation manner comprises at least one of power amplifier bias change, Error Vector Magnitude (EVM) change, radio resource restriction, and cell off.

19. The apparatus of claim 11, wherein, when the base station operates in the ES mode, the controller determines abnormality of a system.

20. The apparatus of claim 19, wherein, when detecting the abnormality of the system, the controller controls the traffic estimator to predict a traffic load of the next time, and controls the traffic abnormality determiner to determine reliability of the traffic load predicted by the traffic estimator.
